(19) United States
(12) Patent Application Publication
(10) Pub. No.: US 2026/0104674 A1
(43) Pub. Date: Apr. 16, 2026

(54) WEARABLE DEVICE WITH DETACHABLE DISPLAY

(71) Applicants: INVENTEC APPLIANCES CORPORATION, New Taipei City (TW); INVENTEC APPLIANCES (PUDONG) CORPORATION, Shanghai (CN)

(72) Inventors: SZU-TSUNG CHANG, New Taipei City (TW); HSIANG TI HSU, New Taipei City (TW); CHUNYI LIN, New Taipei City (TW); SHU-YANG TU, New Taipei City (TW)

(21) Appl. No.: 19/310,276

(22) Filed: Aug. 26, 2025

Related U.S. Application Data
(60) Provisional application No. 63/707,235, filed on Oct. 15, 2024.

(51) Int. Cl. G04G 17/08; F16B 1/00; G04B 37/00; G04G 21/02

(52) U.S. Cl. CPC G04G 17/08; F16B 1/00; G04B 37/0008; G04G 21/025; F16B 2200/83

(57) ABSTRACT

A wearable device with detachable display includes a wristband assembly having a connecting part and a wristband body connected to the connecting part, and a display assembly having a display screen. The wristband assembly is configured for a user to wear and measure physiological information and exercise information of the user when the user wears it. The display assembly is configured to perform an intelligent function. The connecting part of the wristband assembly and the display assembly respectively include a first assembly structure and a second assembly structure corresponding to each other to detachably couple the display assembly and the wristband assembly. Thereby, the wristband assembly and the display assembly can be separated from each other to perform their own functions independently, or assembled with each other to perform both functions and display the functions on the display screen of the display assembly.

The present application is based on, and claims priority from, U.S. provisional application No. 63/707,235 filed on Oct. 15, 2024, the disclosure of which is hereby incorporated by reference herein in its entirety.

### BACKGROUND OF THE INVENTION

### 1. Field of the Invention

The present invention relates to a wearable device, and more particularly, to a wearable device having a display and a wristband detachably connected to each other.

### 2. Description of the Prior Art

With the advancement of technology, smart wearable devices such as smart watches and smart wristbands have become popular among consumers due to their convenience, making them one of the most actively developed areas in the industry. Compared to smart watches, smart wristbands are more compact and focus on allowing users to monitor their health or track their exercise during daily activities or workouts. Smart watches, on the other hand, offer more comprehensive functionality. In addition to the features of smart wristbands, they may also include phone call answering, email checking, social media access, music playback, and voice assistant functions. However, their drawback is that to accommodate these features, smart watches are typically heavier and consume more power, making them less suitable for use during physical activities. Additionally, due to the fact that smart watches are worn on the wrist, their display size is limited by the width of the wrist, making them less convenient for the users to operate the touch screens.

Based on the differences between smart watches and smart wristbands, the users currently have to choose between the two devices according to the usage scenario. However, there are still some scenarios where the users may need both a smart watch and a smart wristband simultaneously. With the current design of smart watches and smart wristbands, it would still cause inconvenience for the users in such scenarios.

### SUMMARY OF THE INVENTION

Therefore, the present invention provides a wearable device with detachable display to solve the problems in the prior art. According to an embodiment of the present invention, the wearable device with detachable display comprises a wristband assembly and a display assembly. The wristband assembly comprises a connecting part and a band body connected to the connecting part, and the connecting part comprises a first assembly structure. The display assembly comprises a display screen and a second assembly structure. The wristband assembly is configured to be worn by a user and measure a physiological information and an exercise information of the user when the user wears the wristband assembly. The display assembly is configured to perform an intelligent function. The first assembly structure and the second assembly structure are corresponding to each other. The first assembly structure and the second assembly structure can be a first magnetic attachment structure and a second magnetic attachment structure, and the display assembly is detachably assembled with the wristband assembly by the first magnetic attachment structure and the second magnetic attachment structure attracted to each other.

In summary, the wearable device with detachable display of the present invention is allows users to choose whether to assemble the display assembly with the wristband assembly, enabling the device to switch between smart watch and smart wristband functions based on the user's application scenario, thereby achieving the functionalities of both a smart watch and a smart wristband with a single device. Additionally, the display assembly and wristband assembly can be powered and charged separately. The display screen of the display assembly can be extended, allowing users to operate the smart watch functions more easily. Therefore, the wearable device with detachable display of the present invention offers greater convenience and broader application scenarios compared to the smart watches or smart wristbands in the prior art.

### BRIEF DESCRIPTION OF THE APPENDED DRAWINGS

FIG. 1 is a schematic diagram illustrating a wearable device with detachable display according to an embodiment of the present invention.

FIG. 2 is a functional block diagram illustrating the wearable device with detachable display according to an embodiment of the present invention.

FIG. 3 is a schematic diagram illustrating a first magnetic attachment structure of a wristband assembly according to another embodiment of the present invention.

FIG. 4 is a schematic diagram illustrating a first magnetic attachment structure and a second magnetic attachment structure according to another embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

In the descriptions of this specification, the terms “an embodiment,” “another embodiment,” or “some embodiments” refer to at least one embodiment of the present invention that includes the specific features, structures, materials, or characteristics described in the embodiment. In this specification, the illustrative expressions of the above terms do not necessarily refer to the same embodiment. Furthermore, the specific features, structures, materials, or characteristics described may be combined in any one or more embodiments in an appropriate manner.

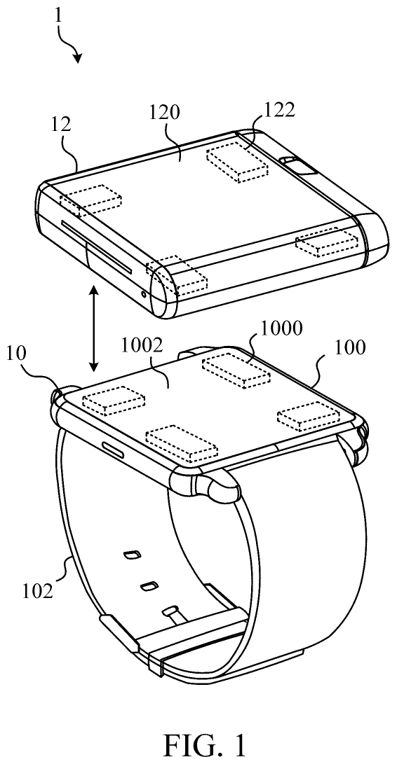

Please refer to FIG. 1. FIG. 1 is a schematic diagram illustrating a wearable device 1 with detachable display according to an embodiment of the present invention. As shown in FIG. 1, in this embodiment, the wearable device 1 with detachable display comprises a wristband assembly 10 and a display assembly 12. The wristband assembly 10 includes a connecting part 100 and a band body 102, wherein the band body 102 is connected to the connecting part 100, and the two ends of the band body 102 can be combined to form a ring-shaped wristband assembly 10 to be worn by the user on their limbs, particularly on their wrist, and move with the user. In this embodiment, the connecting part 100 of the wristband assembly 10 has a first assembly structure, which is a first magnetic attachment structure 1000, located within the connecting part 100 and providing a magnetic attachment effect outward from the connecting part 100. Additionally, the connecting part 100 of the wristband assembly 10 can further include physiological sensors and exercise sensors to measure the physiological information and exercise information of the user wearing the wristband assembly 10, such as, but not limited to, heart rate, breathing, movement speed, or number of steps.

The display assembly 12 includes a display screen 120 and a second assembly structure, wherein the second assembly structure is a second magnetic attachment structure 122 in this embodiment. The display screen 120 can display the intelligent functions provided by the display assembly 12 or the data stored in the display assembly 12, and can also have touch screen functionality. In practice, the display assembly 12 can serve as the display unit of a wearable smart device, such as the watch case and watch face of a smart watch, thereby providing intelligent functions such as, but not limited to, phone call answering, email checking, social media access, music playback, and voice assistant functionality. The second magnetic attachment structure 122 can be configured in the display assembly 12 and positioned near the opposite side relative to the display screen 120 to provide a magnetic attachment effect. Additionally, the configuration of the second magnetic attachment structure 122 is corresponding to the location of the first magnetic attachment structure 1000 in the connecting part 100. By the mutual attraction between the first magnetic attachment structure 1000 and the second magnetic attachment structure 122, the display assembly 12 can be detachably assembled with the wristband assembly 10. In this embodiment, the display assembly 12 is detachably assembled with the wristband assembly 10 by the first magnetic attachment structure 1000 and the second magnetic attachment structure 122, but it is not limited to this configuration in practice. Any device or structure capable of assembling the display assembly 12 and the wristband assembly 10 can serve as the first assembly structure and the second assembly structure of the present invention.

As described above, when the display assembly 12 is separated from the wristband assembly 10, the wristband assembly 10 can be worn separately by the user, thereby achieving the functions such as measuring the user's physiological information and exercise information, i.e., it can be used as a smart wristband. On the other hand, when the display assembly 12 is assembled with the wristband assembly 10 via the first magnetic attachment structure 1000 and the second magnetic attachment structure 122, the display assembly 12 and the wristband assembly 10 can be worn together by the user to achieve intelligent functions such as phone call answering, email checking, social media access, music playback and voice assistant, in addition to the aforementioned functions of measuring the user's physiological information and exercise information, i.e., it can be used as a smart watch.

In this embodiment, the display assembly 12 and the wristband assembly 10 are assembled with each other by corresponding magnetic structures (the first magnetic structure 1000 and the second magnetic structure 122), so the assembly and separation are more convenient compared to other assembly methods, such as locking mechanisms. Therefore, in practice, the user can easily switch the wearable device 1 with detachable display between a smart watch and a smart wristband according to the application scenario without needing to purchase two separate devices for different application scenarios. Furthermore, when switching application scenarios, for example, after exercising and wanting to directly use the smart watch function, the display assembly 12 can be directly assembled with the wristband assembly 10 even without removing the wristband assembly 10 from the wrist. In summary, the wearable device 1 with detachable display of the present invention has extremely high convenience.

In addition, since the wristband assembly 10 in this embodiment can be used independently as a smart wristband, it can include a wristband display 1002 located on the connecting part 100; however, the position of the wristband display is not limited to this in practice. The wristband display 1002 can be connected to the aforementioned physiological sensors and exercise sensors, and can be used to display the physiological information and exercise information of the user wearing the wristband assembly 10, as well as other information such as time. The user can wear the wristband assembly 10 alone for exercise and check the user's physiological information and exercise information, etc., via the wristband display 1002.

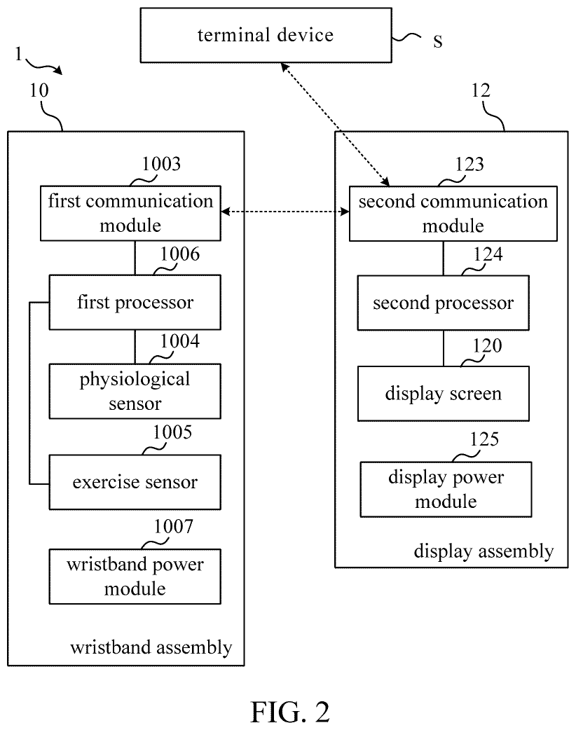

As described above, the display assembly 12 and the wristband assembly 10 can be assembled with each other via the magnetic attachment structures, and the connected display assembly 12 can perform intelligent functions and display the user's physiological information and exercise information measured by the wristband assembly 10. Please refer to FIG. 2. FIG. 2 is a functional block diagram illustrating the wearable device 1 with detachable display according to an embodiment of the present invention. As shown in FIG. 2, in this embodiment, the wristband assembly 10 of the wearable device 1 with detachable display includes a first communication module 1003, a physiological sensor 1004, an exercise sensor 1005, and a first processor 1006 connected to the aforementioned three components. The first processor 1006 can receive the physiological information and the exercise information measured by the physiological sensor 1004 and the exercise sensor 1005. The display assembly 12 further includes a second communication module 123 and a second processor 124, wherein the second processor 124 is connected to the second communication module 123 and the display screen 1002. When the wristband assembly 10 is assembled with the display assembly 12 via the first magnetic attachment structure 1000 and the second magnetic attachment structure 122 as described in the aforementioned embodiment, the first communication module 1003 and the second communication module 123 can communicate with each other, and the second processor 124 can obtain the physiological information and the exercise information measured by the wristband assembly 12 through the first communication module 1003 and the second communication module 123, and display it on the display screen 1002. In addition, the second processor 124 can control the first communication module 1003 to wirelessly communicate with an external terminal device S to perform intelligent functions such as phone call answering, emails checking, and social media access, as described above.

On the other hand, as shown in FIG. 2, the wristband assembly 10 further includes a wristband power module 1007 to supply power to the wristband assembly 10, and the display assembly 12 further includes a display power module 125 to supply power to the display assembly 12. Both modules can have a charging function, enabling the wristband assembly 10 and the display assembly 12 to charge independently. As described above, the display assembly 12 has the smart watch function, so that the display assembly 12 has higher power consumption than that of the wristband assembly 10 and therefore requires frequent charging. By the design of separately powering and charging of the wristband assembly 10 and the display assembly 12 in the present invention, the smart wristband function of the wristband assembly 10 can still be used while the display assembly 12 is charged. For example, the user can wear the wristband assembly 10 during sleep to measure the physiological information while separately charging the display assembly 12.

Conventional watches or smart watches have a fixed relative position between the watch face and the watch band, limiting the users wearing the watches to viewing and operating the watch face from a single direction, thereby restricting their usage scenarios. The wearable device with detachable display of the present invention assembles the display assembly and the wristband assembly via a magnetic attraction mechanism. Through the design of the magnetic attachment structure, the display assembly and the wristband assembly can be assembled at different angles, allowing the user to operate the wearable device with detachable display in various postures. For details on the magnetic attachment structure design, please refer to the following embodiments. It should be noted that the following embodiments are merely examples of the magnetic attachment structure design and do not limit the scope of the present invention thereto.

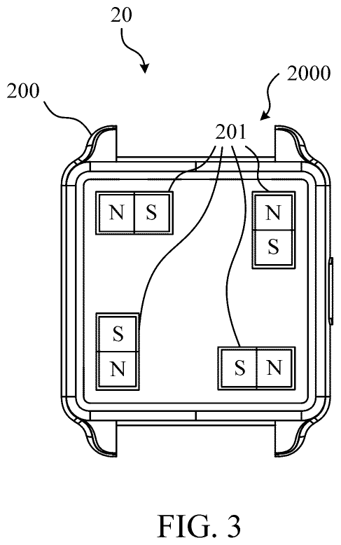

Please refer to FIG. 3. FIG. 3 is a schematic diagram illustrating a first magnetic attachment structure 2000 of a wristband assembly 20 according to another embodiment of the present invention. It should be noted that for the sake of simplicity, FIG. 3 only shows the first magnetic attachment structure 2000 located in the connecting part 200 of the wristband assembly 20, while other units in the connecting part 200 are omitted.

As shown in FIG. 3, the connecting part 200 of the wristband assembly 20 in this embodiment is a square-shaped structure, with first magnet sets 201 configured at each of the four corners of the connecting part 200. Each first magnet sets 201 is configured by two magnets joined with the N pole facing the S pole, and the first magnet sets 201 at the four corners of the connecting part 200 are all configured in the same manner. On the other hand, in this embodiment, the second magnetic attachment structure of the display assembly (not shown in FIG. 3) is also configured with four second magnetic sets at the positions corresponding to each of the first magnetic sets 201. Each of the second magnetic sets similarly comprises two magnets joined with the N pole facing the S pole. It should be noted that the N poles and the S poles of the two magnets in the first magnet sets 201 are configured oppositely to the N poles and the S poles of the two magnets in the second magnet sets, so that the first magnet sets 201 and the second magnet sets attract each other in an N pole to S pole configuration. By configuring the first magnet sets 201 with the same configuration at the four corners of the connecting part 200 and the second magnet sets with the corresponding configuration but opposite polarity on the display assembly, the display assembly can be assembled with the wristband assembly 200 in four different orientations by 90-degree rotation. Therefore, the user can freely assemble the display assembly with the wristband assembly according to their needs, making it more convenient to use. Additionally, although the connecting part 200 in this embodiment is a square-shaped structure, the shape is not limited to this in practice. It can be designed as a circular disc or other shapes capable of supporting the display assembly, and the four first magnet sets can be arranged as described above to achieve the effect of assembling the display assembly with the wristband assembly in four different orientations by 90-degree rotation.

In this embodiment, the two magnets of the first magnet sets 201 and the second magnet sets are joined with the N pole facing the S pole, strengthening the magnetic field at the joint and concentrating the external magnetic field. The attraction range is also expanded due to the synergistic effect of the two magnets, thereby enhancing magnetic attraction force in a specific area to enable the attachment of larger or heavier objects. Therefore, the display assembly and wristband assembly, through the first magnetic attachment structure and second magnetic attachment structure of this embodiment, can be assembled in different orientations, and the wearable device after assembly is highly stable and does not have accidental detachment of the display assembly.

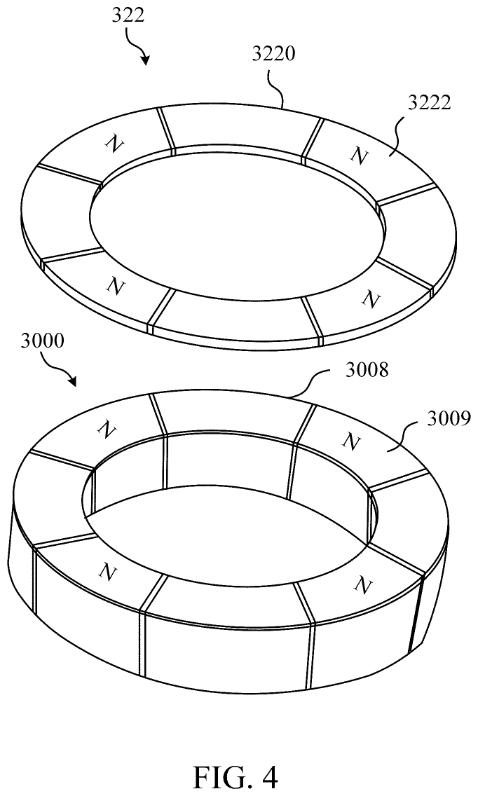

Please refer to FIG. 4. FIG. 4 is a schematic diagram illustrating a first magnetic attachment structure 3000 and a second magnetic attachment structure 322 according to another embodiment of the present invention. It should be noted that the first magnetic attachment structure 3000 and the corresponding second magnetic attachment structure 322 are respectively configured in the wristband assembly and the display assembly. However, for the sake of simplicity in the figure, FIG. 4 only illustrates the first magnetic attachment structure 3000 and the corresponding second magnetic attachment structure 322, while other components of the wristband assembly and the display assembly are omitted.

As shown in FIG. 4, the first magnetic attachment structure 3000 of this embodiment includes a first annular member 3008 and a plurality of first magnet sets 3009 configured at equal intervals on the first annular member 3008. The second magnetic attachment structure 322 comprises a second annular member 3220 and a plurality of second magnet sets 3222 configured at intervals on the second annular member 3220. The second annular member 3220 and the second magnet sets 3222 are configured correspondingly to the first annular member 3008 and the first magnet sets 3009, respectively, and are oriented such that the N poles face the S poles. As a result, the display assembly and the wristband assembly can be assembled by one-to-one attraction between the first magnet sets 3009 and the second magnet sets 3222. Furthermore, since the first magnet sets 3009 and the second magnet sets 3222 are both configured at the same intervals on the first annular member 3008 and the second annular member 3220, the display assembly can be assembled with the wristband assembly in different orientations corresponding to these intervals, allowing the user to choose the assembly direction of the display assembly and the wristband assembly according to their needs, so as to ensure that the display screen faces the user in all postures to enhance usability.

In addition, the display assembly 12 in the aforementioned embodiment may be an extendable display screen. When the display assembly 12 is assembled with the wristband assembly 10, the display screen 120 can extend outward (e.g., the display screen 120 can be a flexible display panel), thereby increasing the display area and the touch area. Therefore, the users can more easily operate the display assembly 12, enhancing the convenience of using its intelligent functions.

In the aforementioned embodiment, after the display assembly 12 is assembled with the wristband assembly 10, it can communicate with the wristband assembly 12 by the first communication module 1003 and the second communication module 123 to execute intelligent functions or display the physiological information and the exercise information, as shown in FIG. 2. However, since the display assembly and wristband assembly of the wearable device can be used individually or in combination, in some application scenarios, the display assembly must determine whether it is the default wristband assembly and whether the intelligent functions of the display assembly can be fully utilized. For example, if the user loses the display assembly, it is necessary to prevent someone who finds the display assembly from directly accessing the internal data of the display assembly using a different wristband assembly. Alternatively, if the user wants to borrow another's display assembly to display the physiological information and the exercise information measured by the wristband assembly, accessing the internal data of this display assembly must be prevented.

In one embodiment of the present invention, the aforementioned application scenarios can be achieved through an authentication method for the wristband assembly by the display assembly of the wearable device with detachable display. It should be noted that the authentication method of this embodiment can be implemented by the wearable device 1 with detachable display shown in FIG. 1 to FIG. 2, so the following description of this method is based on the units of the wearable device 1 with detachable display.

First, the wristband assembly 10 and the display assembly 12 are in a separated state and each performs its own functions. When the display assembly 12 is assembled with the wristband assembly 10 by the mutual attraction between the first magnetic attachment structure 1000 and the second magnetic attachment structure 122, the second communication module 123 of the display assembly 12 can receive authentication information about the wristband assembly 10 transmitted from the first communication module 1003. In practice, the second processor 124 of the display assembly 12 can determine whether to request and receive the authentication information from the wristband assembly 10 based on whether the signal strength (RSSI signal) between the first communication module 1003 and the second communication module 123 exceeds a threshold value. After the display assembly 12 receives the authentication information from the wristband assembly 10, the second processor 124 first compares the authentication information with an authentication list stored in the display assembly 12. When the second processor 124 confirms that the authentication information matches an entry in the authentication list, i.e., the wristband assembly 10 is in the authentication list stored in the display assembly 12, the display assembly 12 enables its intelligent functions for the user wearing the wristband assembly 10, and the user can also obtain and display information about the wristband assembly 10 through the display assembly 12.

If the second processor 124 of the display assembly 12 confirms that the authentication information does not match any entry in the authentication list, i.e., the wristband assembly 10 is not in the authentication list stored in the display assembly 12, the second processor 124 of the display assembly 12 displays an authentication procedure requirements for the user wearing the wristband assembly 10 on the display screen 120. The user of the wristband assembly 10 can perform the authentication procedure, such as entering a verification code, and when the second processor 124 confirms that the authentication procedure is passed, the display assembly 12 can enable the display screen 120 to display the physiological information and exercise information measured by the wristband assembly 10. Thereby, when the display assembly 12 of the wearable device 1 of the user is lost, charging, or placed in another location, the user can temporarily borrow another's display assembly 12 to check the physiological information, the exercise information, or time detected by the wristband assembly 10. Additionally, when the second processor 124 confirms that the authentication procedure is not passed, the display assembly 12 generates an authentication failure warning message and does not enable any functions of the display assembly 12. In this situation, even if the display assembly 12 is lost, anyone who finds it cannot arbitrarily assemble it with any wristband assembly 10 to access the data stored in the display assembly 12, nor can they use the intelligent functions of the display assembly 12 or display the physiological information and the exercise information of the wristband assembly 10. Thereby, it prevents unauthorized individuals from stealing information or misusing the display assembly 12.

In summary, the wearable device with detachable display of the present invention separates and assembles the display assembly and the wristband assembly by the magnetic attachment structures, enabling smart wristband functionality and smart watch functionality in various application scenarios without the need to purchase both the smart wristband and the smart watch simultaneously. The magnetic attraction allows the display assembly and wristband assembly to be easily assembled and separated, and depending on the configuration of the magnetic structures, users can also decide the orientation in which the display assembly and wristband assembly are assembled. Additionally, the display assembly can be extended to increase the display area and the touch screen area. The wearable device with detachable display also has a special authentication procedure between the display assembly and the wristband assembly to prevent information in the display assembly from being stolen. Therefore, the wearable device with detachable display of the present invention offers greater convenience in use and broader application scenarios.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A wearable device with detachable display, comprising:
a wristband assembly, comprising a connecting part and a band body connected to the connecting part, the connecting part comprising a first assembly structure, the wristband assembly being configured to be worn by a user and measure a physiological information and an exercise information of the user when the user wears the wristband assembly;
a display assembly, comprising a display screen and a second assembly structure, the second assembly structure being corresponding to the first assembly structure, the display assembly being configured to perform an intelligent function;
wherein, the display assembly is detachably assembled with the wristband assembly by the first assembly structure and the second assembly structure assembled with each other.

2. The wearable device with detachable display of claim 1, wherein the first assembly structure is a first magnetic attachment structure and the second assembly structure is a second magnetic attachment structure, the connecting part is a square-shaped connecting part, the first magnetic attachment structure comprises a plurality of first magnet sets respectively configured at the corners of the square-shaped connecting part, the second magnetic attachment structure comprises a plurality of second magnet sets corresponding to the first magnet sets, the display assembly is assembled with the wristband assembly in different orientations by the first magnet sets and the second magnet sets attracted to each other.

3. The wearable device with detachable display of claim 1, wherein each of the first magnet sets comprises two magnets joined with the N pole facing the S pole, each of the second magnet sets comprises two magnets joined with the N pole facing the S pole, the N poles and the S poles of the two magnets of each of the first magnet sets are corresponding to the S poles and the N poles of the two magnets of each of the second magnet sets, so as to enable each of the first magnet sets and each of the second magnet sets to be attracted to each other.

4. The wearable device with detachable display of claim 1, wherein the first assembly structure is a first magnetic attachment structure and the second assembly structure is a second magnetic attachment structure, the first magnetic attachment structure comprises a first annular member and a plurality of first magnet sets configured at intervals on the first annular member, the second magnetic attachment structure comprises a second annular member and a plurality of second magnet sets configured at intervals on the second annular member, the display assembly is assembled with the wristband assembly in different orientations by the first magnet sets and the second magnet sets attracted to each other.

5. The wearable device with detachable display of claim 1, wherein the wristband assembly comprises a physiological sensor and an exercise sensor, the physiological sensor is configured to measure the physiological information of the user when the user wears the wristband assembly, the exercise sensor is configured to measure the exercise information when the user wears the wristband assembly, the wristband assembly comprises a wristband display connected to the physiological sensor and the exercise sensor to display the physiological information and the exercise information.

6. The wearable device with detachable display of claim 1, wherein the wristband assembly further comprises a first communication module, the display assembly further comprises a second communication module, the first communication module and the second communication module are configured to communicate with each other when the display assembly is assembled with the wristband assembly.

7. The wearable device with detachable display of claim 6, wherein the display assembly further comprises a processor connected to the second communication module and the display screen, the processor is configured to authenticate the wristband assembly according to authentication information received by the second communication module from the first communication module when the display assembly is assembled with the wristband assembly.

8. The wearable device with detachable display of claim 7, wherein the processor is configured to compare the authentication information and an authentication list when the display assembly is assembled with the wristband assembly, and the processor controls the display assembly to perform the intelligent function when the authentication information matches an entry in the authentication list; when the authentication information do not match any entry in the authentication list, the processor controls the display assembly to require the user to perform an authentication procedure, and when the authentication procedure is passed, the processor controls the display screen of the display assembly to display the physiological information and the exercise information of the user measured by the wristband assembly.

9. The wearable device with detachable display of claim 1, wherein the display screen of the display assembly is an extendable display screen configured to extend to enlarge the display area when the display assembly is assembled with the wristband assembly.

10. The wearable device with detachable display of claim 1, wherein the wristband assembly comprises a wristband power module configured to supply power to the wristband assembly, the display assembly comprises a display power module configured to supply power to the display assembly.
